(19) United States
(12) Patent Application Publication
(10) Pub. No.: US 2009/0290559 A1
(43) Pub. Date: Nov. 26, 2009

(54) METHOD AND APPARATUS FOR HARQ AUTONOMOUS RETRANSMISSIONS

(75) Inventors: Benoit Pelletier, Roxboro (CA); Paul Marinier, Brossard (CA); Diana Pani, Montreal (CA); Christopher R. Cave, Montreal (CA); Fatou A. Diop, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL PATENT HOLDINGS, INC., Wilmington, DE (US)

(21) Appl. No.: 12/429,056

(22) Filed: Apr. 23, 2009

Related U.S. Application Data
(60) Provisional application No. 61/047,502, filed on Apr. 24, 2008.
(60) Provisional application No. 61/047,914, filed on Apr. 25, 2008.
(60) Provisional application No. 61/159,730, filed on Mar. 12, 2009.

(51) Int. Cl. H04W 72/04; H04J 3/00

(52) U.S. Cl. 370/336; 714/748

(57) ABSTRACT

A method and an apparatus for performing uplink hybrid automatic repeat request (HARQ) transmission in a burst are disclosed. A wireless transmit/receive unit (WTRU) may transmit a transmission burst over at least two consecutive transmission time intervals (TTIs) via a HARQ process configured for transmission burst. An E-DCH dedicated physical control channel (E-DPCCH) power offset may be set to the transmission burst-specific E-DPCCH gain factor value. The WTRU may calculate a power of the E-DPCCH by dividing a conventional E-DPCCH power offset by a total number of TTIs in the transmission burst. The WTRU may transmit the E-DPCCH only during a first TTI of the transmission burst. The supported E-TFCs may be a second set of supported E-TFCs determined only for use with the transmission burst. The WTRU may determine the set of supported E-TFCs and the E-TFC for transmission based on a number of TTIs in the transmission burst.

### CROSS REFERENCE TO RELATED APPLICATIONS

This application claims the benefit of U.S. provisional application Nos. 61/047,502 filed Apr. 24, 2008, 61/047,914 filed Apr. 25, 2008, and 61/159,730 filed Mar. 12, 2009, which are incorporated by reference as if fully set forth.

### FIELD OF INVENTION

This application is related to wireless communications.

### BACKGROUND

As part of ongoing evolution of the wideband code division multiple access (WCDMA) standards, an enhanced uplink, (also referred to as high speed uplink packet access (HSUPA)), has been introduced into third generation partnership project (3GPP) standards Release 6 to improve the coverage and throughput and reduce the delay in uplink. For operation of the enhanced uplink, two new medium access control (MAC) entities (MAC-es/MAC-e), a new transport channel called enhanced dedicated channel (E-DCH), five new physical channels, and a mechanism implemented in one of the new MAC entities for hybrid automatic repeat request (HARQ) retransmissions in the physical layer have been introduced.

On the wireless transmit/receive unit (WTRU) side, the two new MAC entities (MAC-es/MAC-e) handle HARQ operations, scheduling, multiplexing, E-DCH transport format combination (E-TFC) selection, etc. On the UMTS terrestrial radio access network (UTRAN) side, the MAC-e entity is located in a Node B and the MAC-es entity is located in a radio network controller (RNC). The MAC-e is responsible for HARQ retransmission, scheduling, and demultiplexing, and the MAC-es is responsible for reordering and combining (for macro-diversity).

The E-DCH is an enhancement to the conventional dedicated transport channel called dedicated channel (DCH). The new physical channels for E-DCH are E-DCH dedicated physical data channel (E-DPDCH) and E-DCH dedicated physical control channel (E-DPCCH) on the uplink, and E-DCH absolute grant channel (E-AGCH), E-DCH relative grant channel (E-RGCH), and E-DCH HARQ indicator channel (E-HICH) on the downlink. The E-DPDCH carries the E-DCH transport channel, (i.e., it carries information data). The E-DPCCH is always transmitted with the E-DPDCH. The E-DPCCH is a control channel carrying an E-DCH transport format combination index (E-TFCI), a retransmission sequence number (RSN) and a happy bit. The E-AGCH carries an absolute grant values and an E-DCH radio network temporary identity (E-RNTI). The E-RGCH carries a relative grant value (serving and non-serving). The E-HICH carries an uplink E-DCH positive acknowledgement (ACK) or negative acknowledgement (NACK) feedback.

The E-DPCCH is always transmitted simultaneously with the E-DPDCH. A radio link may handle several E-DPDCHs and only one E-DPCCH. To decode the data received over the E-DPDCH(s) properly, the Node B needs the E-TFCI and the RSN transmitted over the E-DPCCH. The E-TFCI indicates the transport block size (TBS). The transport format is recovered by the Node B by using the known one-to-one mapping between the TBS and the transport format. The RSN indicates the uplink HARQ retransmission number. This information assists the Node B soft buffer management, and also provides the redundancy version (RV) index, which signals to the Node B the puncturing and repetition configuration. The happy bit is used by the UTRAN to determine if the WTRU is satisfied with the current serving grant or not. The happy bit is not essential for decoding the transport block.

The E-DPCCH comprises ten (10) bits to carry the E-TFCI, the RSN and the happy bit. The power setting of the E-DPCCH is determined in relation to a dedicated physical control channel (DPCCH), which varies as a function of channel condition to meet a given signal-to-interference ratio (SIR) target at the UTRAN. The E-DPCCH power is also set such that the control channel overhead is minimized for a given probability of data error detection.

For HSUPA to become a viable alternative to the legacy DCH for services like voice, an improvement of the received energy per information per bit for the power limited WTRUs is necessary. This improvement may provide an enhancement of the uplink coverage that may approach the DCH coverage, even for 2 ms transmission time intervals (TTIs). In a practical deployment, the uplink coverage is typically limited by the power restriction imposed on WTRUs, and is directly linked to the distance to the serving Node B depending on the SIR target set by the UTRAN.

To alleviate this issue, approaches for increasing the transmit time of the WTRU for each information bit have been proposed. In one approach, it is proposed to use autonomous retransmission. As opposed to a normal HARQ retransmission, the autonomous retransmission mechanism comprises a fast retransmission of the same transport block on consecutive TTI(s) without waiting for a NACK feedback. FIG. 1 shows HARQ autonomous retransmission. In FIG. 1, a WTRU transmits a transmission burst of three TTIs including an initial transmission at TTI #0 and retransmissions of the same transport block at TTIs #1 and #2 via the same HARQ process #0. After receiving a NACK in TTI #6, the WTRU retransmits the same burst.

In another approach, it has been proposed to increase the transmission time for a given data packet, thereby increasing the transmission time interval to an integer number of 2 ms TTIs. In this approach the transport format is adjusted appropriately to the transmission burst duration.

Due to the several retransmissions of the same transport block or the increase of packet transmission duration, some control information transmitted over the E-DPCCH may be redundant, and unnecessarily increase the control channel overhead resulting in a reduced coverage.

With autonomous retransmissions more energy per bit is potentially available to the WTRU to transmit data. The WTRU needs to determine the amount of data to include in the packet to be transmitted (i.e., MAC-e or MAC-i PDU). The WTRU also needs to determine how many autonomous retransmissions to perform in the absence of HARQ feedback and what E-DPDCH/DPCCH power ratio to use for each autonomous transmission. This is achieved via E-TFC restriction and selection procedures.

### SUMMARY

A method and an apparatus for performing uplink HARQ transmission in a burst are disclosed. A WTRU may transmit a transmission burst over at least two consecutive TTIs via a HARQ process configured for transmission burst. An E-DPCCH power offset may be set to the transmission burst-specific E-DPCCH gain factor value.

The WTRU may calculate a power of the E-DPCCH by dividing a conventional E-DPCCH power offset by a total number of TTIs in the transmission burst. The WTRU may transmit the E-DPCCH only during a first TTI of the transmission burst. The WTRU may scale an E-DPDCH gain factor during the first TTI of the transmission burst to avoid transmitting above a maximum allowed transmission power. The WTRU may scale an E-DPDCH gain factor for at least one TTI of the transmission burst such that a total required transmission power is transmitted during the transmission burst. The WTRU may transmit the E-DPDCH during the transmission burst such that a maximum allowed transmission power is reached.

The set of supported E-TFCs may be a second set of supported E-TFCs that is determined only for use with the transmission burst. The second set of supported E-TFCs may be determined on a condition that a largest supported E-TFC is smaller than a minimum E-TFC. The second set of supported E-TFCs may be determined using a second set of reference power offsets.

The WTRU may perform uplink HARQ transmission in a burst on at least one of conditions that a largest supported E-TFC is smaller than a minimum E-TFC, the selected E-TFC is provided with a transmission burst duration longer than one TTI, a transmission power associated to the selected E-TFC exceeds a maximum allowed transmission power, or a previous HARQ transmission has failed.

The WTRU may determine the set of supported E-TFCs and the E-TFC for transmission based on a number of TTIs in the transmission burst. The WTRU may receive a power offset for different transmission burst HARQ profile, and apply an additional power offset to an E-DPDCH gain factor.

### BRIEF DESCRIPTION OF THE DRAWINGS

A more detailed understanding may be had from the following description, given by way of example in conjunction with the accompanying drawings wherein:

FIG. 1 shows HARQ autonomous retransmission;

FIGS. 2-4 show HARQ autonomous retransmissions in accordance with different embodiments;

FIG. 5 is a flow diagram of an example process for E-TFC selection in accordance with this embodiment; and

FIG. 6 is a block diagram of an example WTRU.

### DETAILED DESCRIPTION

When referred to hereafter, the terminology “WTRU” includes but is not limited to a user equipment (UE), a mobile station, a fixed or mobile subscriber unit, a pager, a cellular telephone, a personal digital assistant (PDA), a computer, or any other type of user device capable of operating in a wireless environment. When referred to hereafter, the terminology “Node B” includes but is not limited to a base station, a site controller, an access point (AP), or any other type of interfacing device capable of operating in a wireless environment. Hereinafter, the terminology “transmission burst” refers to the transmission of a data packet with at least one consecutive autonomous retransmission. The terminology “transmission burst” may also refer to the transmission of a data packet over an integer number (larger than 1) of TTIs, wherein the TTIs may not necessarily be repeated. The transmission burst is said to have failed if the Node B cannot decode it. Hereinafter, the terminologies “autonomous retransmissions”, “TTI bundling”, “transmission burst”, “autonomous transmission”, “TTI repetition” may be used interchangeably.

The embodiments described below are applicable to both autonomous retransmissions and TTI length extension (transmission of a packet over multiple TTIs). However, the embodiments will be described in the context of autonomous retransmissions for simplicity.

When a HARQ process is configured by a higher layer for N autonomous retransmissions, (i.e., N+1 TTIs in the transmission burst), the WTRU disables the following NHARQ processes to leave room for the transmission burst. Disabling may include, but is not limited to, deactivation of HARQ processes. For example, if HARQ process #0 is configured for three (3) autonomous retransmissions, the WTRU disables HARQ processes #1, 2 and 3 so that the next HARQ process available becomes HARQ process #4.

To decode the E-DPDCH, a Node B needs to know a redundancy version (RV) index, (i.e., s and r parameters for rate matching). Conventionally, the RV index is implicitly linked to the retransmission sequence number (RSN) via a table-lookup. When the WTRU sends an E-DCH transport block to the Node B, the associated RSN is also simultaneously sent during the same TTI over the E-DPCCH. The RSN may be incremented by the WTRU at each HARQ retransmission of the transmission burst. The WTRU may be configured to transmit using a different RV index for each of the autonomous retransmissions.

The RV index for each TTI in the transmission burst may be implicitly signaled as a function of one or more of the following parameters: RSN, TTI number (TTIN), number of autonomous retransmissions (N), code rate, connection frame number (CFN), or other relevant parameters. For 10 ms TTI, the TTIN equals to CFN. For 2 ms TTI, the TTIN=(5×CFN+subframe number).

In accordance with one embodiment, the RV index may be incremented for each consecutives autonomous retransmissions in a transmission burst, and when a transmission burst fails, the WTRU resets the RV index. In this case, Equation (1) may be used to recover the RV index:

E-DCH RV index=((TTIN−TTINs)mod 4); Equation (1)

where TTINs is the TTIN where the transmission burst starts for the HARQ process. The Node B may determine the value of the RV based on the known WTRU timing, and the HARQ configuration.

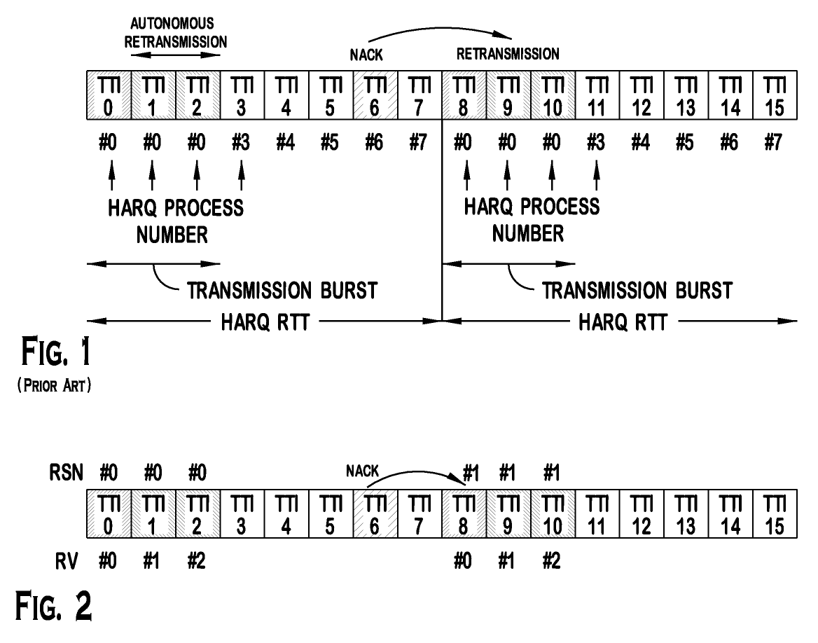

This embodiment is illustrated in FIG. 2 for the case of two (2) autonomous retransmissions as an example. A WTRU transmits a transmission burst of three TTIs (TTI 0−TTI 2) including the initial transmission. The WTRU increments the RV index each time the transport block is retransmitted, (e.g., the RV index is incremented for TTI 1 and TTI 2, respectively). After a NACK to the transport block is received at TTI 6, the WTRU retransmits the transmission burst in TTI 8−TTI 10 while resetting the RV index, (i.e., the RV index is reset to ‘0’ for TTI 8 and incremented by one for each subsequent retransmission).

Alternatively, the RV index may not be reset when the transmission burst fails. In this case, Equation (2) may be used to recover the RV index:

E-DCH RV index=((TTIN+RSN×(N+1)−TTINs)mod 4). Equation (2)

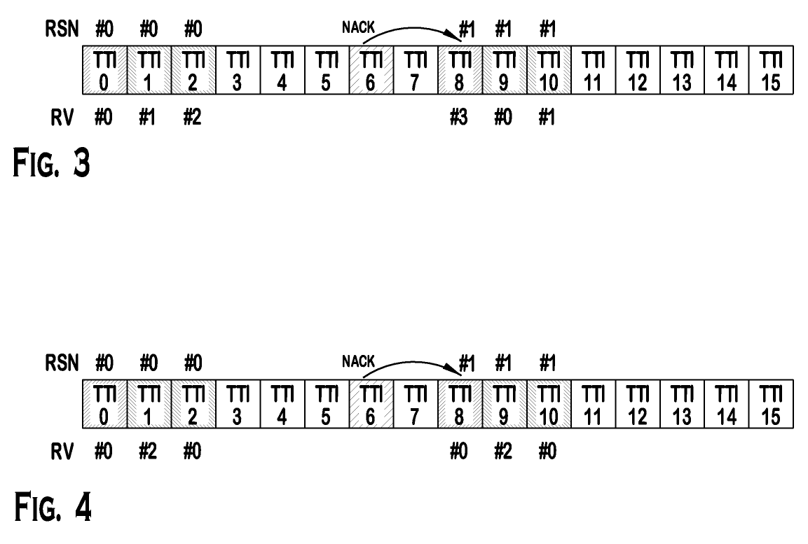

The Node B may determine the value of the RV index based on the known WTRU timing, the HARQ configuration, and the RSN. This embodiment is illustrated in FIG. 3 for the case of 2 autonomous retransmissions. A WTRU transmits a transmission burst of three TTIs (TTI 0−TTI 2) including the initial transmission. The WTRU increments the RV index each time the transport block is retransmitted, (i.e., the RV index is incremented for TTI 1 and TTI 2, respectively). After a NACK to the transport block is received at TTI 6, the WTRU retransmits the transmission burst in TTI 8−TTI 10. The RV index is not reset for the subsequently retransmitted transmission burst, (i.e., the RV index is set to ‘3’ for TTI 8 in accordance with Equation (2) and incremented by one for each subsequent retransmission).

In accordance with another embodiment, the network may define an RV pattern for each transmission burst. For example, in the case of 2 autonomous retransmissions, the network may configure the WTRU to use RV=0, 2, 0 for the three transmissions of the transmissions burst, respectively. Alternatively this RV pattern may be defined in the standard. Optionally, a different pattern may be used for each HARQ retransmission.

The Node B may determine the RV index based on the known WTRU timing, the HARQ configuration, and the RSN. This embodiment is illustrated in FIG. 4 for the case of 2 autonomous retransmissions. A WTRU transmits a transmission burst of three TTIs (TTI 0−TTI 2) including the initial transmission. The RV index is set in accordance with the configured pattern, (i.e., RV=0, 2, 0). After a NACK to the transport block is received at TTI 6, the WTRU retransmits the transmission burst in TTI 8−TTI 10 while setting the RV index in accordance with the configured pattern.

In accordance with another embodiment, the WTRU may use an RV index for each transmission that would result in an equivalent RV index that would be used if the data was sent using normal transmission, (i.e., no transmission burst). For example, if a fourth transmission is taking place, the fourth transmission could be the third autonomous retransmission of the first burst, or the first or second of the second burst, and the RV index chosen for this transmission may be the same RV index that would have been chosen if the data was sent for the fourth time using normal HARQ operation. The TTIN would correspond to the TTI number at which the fourth transmission would be sent, (i.e., fourth HARQ RTT). Table 1 below may be used to determine the RV index to use.

TABLE 1

| Trans- | | |
|---|---|---|
| mission | N_{sys}/N_{e, data, j} < ½ | ½ ≦ N_{sys}/N_{e, data, j} |
| Index | E-DCH RV Index | E-DCH RV Index |
| 0 | 0 | 0 |
| 1 | 2 | 3 |
| 2 | 0 | 2 |
| 3 | [└TTINₙₒᵣₘₐₗ/N_{ARQ}┘ mod 2] × 2 | └TTINₙₒᵣₘₐₗ/N_{ARQ}┘ mod 4 |

The transmission index in Table 1 is determined using the following equations:

If (TTIN+RSN×(N+1)−TTINs)<3 Transmission Index=TTIN+RSN×(N+1)−TTINs; Equation (3)

Else

Transmission Index=3; Equation (4)

N_{sys}, N_{e,data,j}, N_{ARQ} are defined in 3GPP TS 25.212. TTINₙₒᵣₘₐₗ is the TTIN in which the N-th transmission would have been sent if normal HARQ was being used. TTINₙₒᵣₘₐₗ may be determined using the following equation:

TTINₙₒᵣₘₐₗ=TTINs+[TTIN−TTINs+RSN×N]×N_{ARQ}. Equation (5)

Alternatively, the RV index corresponding to transmission index 3 may be dependent on TTIN in which the current data is being transmitted.

Alternatively, the transmission index may be determined by the following equation:

Transmission Index=(TTIN+RSN×(N+1)−TTINs)mod x; Equation (6)

where x is the possible number of RV index the WTRU is allowed to use. For example, if 8 RV index patterns are defined, x would be equivalent to 8. The E-DCH RV index for both columns defined in Table 1 may be a new table (i.e., pattern) that is pre-defined or alternatively configured by the network.

The network may also configure the WTRU to use a table where the RV index may be determined with an index depending on one or more of the following parameters: RSN, TTIN, N, code rate, CFN, and the like.

Alternatively, the E-DPCCH format may be changed to allow explicit signaling of the RV index to the network. This may be achieved by reducing the number of bits used to indicate the E-TFCI. When configured for autonomous retransmission, the WTRU may be configured to use only a subset of the E-TFCI, and a number of bits less than conventional 7 bits may be used to indicate the E-TFCI and the remaining bits may be used to indicate the RV index. The WTRU re-interprets the bits when initiating or configured to initiate autonomous retransmissions.

Embodiments for E-DPCCH power reduction are explained hereafter. The E-DPCCH absolute power is currently calculated as an offset (signaled by higher layers) to the DPCCH power.

In accordance with one embodiment, the total E-DPCCH power that would have normally be allocated to the E-DPCCH when no autonomous retransmissions are configured may be spread over the transmission burst duration to potentially achieve a gain due to time diversity and also take advantage of a lower instantaneous transmission power to increase uplink coverage. The UTRAN may configure the WTRU via higher layer signaling to use a specific E-DPCCH power offset only for HARQ processes configured for autonomous retransmissions or transmission bursts. The same power offset may be used throughout the transmission burst.

Alternatively, the WTRU may calculate the E-DPCCH power offset or gain factor associated to HARQ processes configured for autonomous retransmissions or transmission burst based on the value of the E-DPCCH power offset configured for normal HARQ processes (i.e., no autonomous retransmissions or transmission bursts). For example, this may be achieved by scaling the conventional E-DPCCH power offset by the total number of TTIs in a transmission burst (N+1) configured for that HARQ process.

Depending on the number of consecutives TTIs in a transmission burst, the network may configure the WTRU to use Equation (7) or (8) to calculate the power offset:

Applied E-DPCCH power offset=Configured E-DPCCH power offset/(N+1); Equation (7)

Applied E-DPCCH gain factor=(Configured E-DPCCH power offset/(N+1))−Δ; Equation (8)

where N is the number of retransmissions in a transmission burst, (i.e., N+1 is the total number of TTIs in a transmission burst), and A is a parameter configurable by the network, which may depend, for example, on the channel conditions.

Alternatively, the power of the E-DPCCH may take the same value as currently specified in the 3GPP standards for the first TTI in a transmission burst, and then take value 0 for the following N autonomous retransmissions or TTIs in a transmission burst. This implies that the E-DPCCH is only transmitted during the first TTI of the transmission burst. Since the values transmitted over the E-DPCCH for the first transmission of the burst remain unchanged for the subsequent burst re-transmission(s), (i.e., RSN and E-TFCI are unchanged), the E-DPCCH does not need to be sent for every autonomous retransmissions. This would save uplink power on autonomous retransmissions. By allocating a smaller portion of the instantaneous power to the E-DPCCH, more power (per TTI) may be allocated to the data part, (i.e., E-DPDCH), resulting in a coverage increase. Thus, for the first TTI in a transmission burst, the WTRU may transmit the E-DPDCH simultaneously with the E-DPCCH, but the power of the E-DPDCH may be scaled to avoid transmitting above the maximum allowed power. Optionally, the gain factor for the E-DPDCH is set to a different level for the first TTI in a transmission burst to avoid power scaling.

The E-DPDCH gain factor may be adjusted by the WTRU to ensure that the total power required for the chosen E-TFC is transmitted during the entire transmission burst. This may be achieved as follows. If β_{ed,first,TTI} is the largest E-DPDCH gain factor possible during the first TTI, and if β_{ed,Required} is the gain factor required for the given E-TFC if it were to be transmitted during a single TTI, then the gain factor for the N TTIs not carrying the E-DPCCH, β_{ed,actual}, may be obtained as follows:

$${β}_{ed , acutal} = \sqrt{\frac{{β}_{ed , Required}^{2} - {β}_{ed , FirstTTI}^{2}}{N - 1}} . \qquad Equation ( 9 )$$

Optionally, the WTRU may not transmit the E-DPDCH during the first TTI in a transmission burst, in which case the E-DPDCH gain factor for the remaining N TTIs in the transmission burst may also be obtained using the above Equation (9) with β_{ed,first,TTI} set to 0. In another alternative, the E-DPDCH gain factor may always be set such that the WTRU transmits at maximum power, regardless of the required E-DPDCH amplitude ratio.

In accordance with another embodiment, in order to reduce the number of E-DPCCH retransmissions in a transmission burst, the E-DPCCH may be transmitted periodically during a transmission burst depending on the number of autonomous retransmissions or the number of TTIs in the transmission burst. This is particularly useful if the first E-DPCCH is not properly decoded by the network, which would imply that the Node B will not be able to decode the subsequent autonomous retransmissions sent by the WTRU without an E-DPCCH. In this particular case, the network may configure the WTRU to send the E-DPCCH M times during a transmission burst, where M is a parameter which may be set by the network depending on the number of autonomous retransmissions. In certain TTIs during a transmission burst, the E-DPDCH may be transmitted without the E-DPCCH control information. For example, the network may configure the WTRU to send the E-DPCCH every second TTIs, such that if the number of autonomous retransmissions N in a transmission burst is three, the E-DPCCH will be transmitted during TTI #0 and TTI # 2. Alternatively, the WTRU may be pre-configured or configured by the network to always send the E-DPCCH on the first and last TTI of the transmission burst. If the number of TTIs in a transmission burst is N_{TX}=N+1, then the E-DPCCH would be transmitted during TTI #0 and TTI #N.

Embodiments for optimizing the channel control information are disclosed hereafter. The conventional TFCI field in the DPCCH is an optional field depending on the service provided by the DCH. The TFCI field may be mapped to 0, 2, 3, or 4 bits depending on the slot format. When no service or a fixed-rate service is mapped on the DCH, the DPCCH does not include the TFCI. This could be the case in a system where only the E-DCH is used.

In accordance with one embodiment, the network may configure a table of E-TFCI that the WTRU is allowed to use for a given service. The TFCI field of the DPCCH may then be used to transmit the E-TFCI information. From this information, the network may recover the TBS and the transport format of the associated E-DPDCH.

Alternatively, the WTRU may use the TFCI field of the DPCCH to carry the RSN and the happy bit, while the E-TFCI may be carried over a new E-DPCCH-like channel (different coding to account for a different number of input bits to code).

In accordance with another embodiment, the E-DPDCH may be transmitted without the associated E-DPCCH. In this case, the UTRAN may define a subset of TBS and modulation that the WTRU is allowed to use on a certain subset of HARQ processes. The Node B performs blind E-TFCI decoding. For example, the happy bit may optionally be included in the MAC header and the RSN may be indicated using a new low power physical channel (2 bits) spread over the total transmission burst. Another option for the RSN is to introduce a new dedicated physical uplink channel using 1 bit to inform the Node B in the retransmission cases, (e.g., similar to the new data indicator on the downlink).

The E-DPDCH may be sent without the E-DPCCH only for the first transmission burst. If the first transmission burst is unsuccessful, the WTRU may send the subsequent transmission bursts with the associated E-DPCCH indicating the updated RSN. The E-DPCCH for the second transmission burst may be sent using any of the methods described above.

E-DPCCH-less transmission may be linked with autonomous retransmission only such that the indication to start autonomous retransmission may also imply that the WTRU starts E-DPCCH-less transmission. Alternatively, an independent network signaling may be used to indicate to the WTRU to start E-DPCCH-less operations. The signaling includes, but is not limited to, RRC message indicating the limited E-TFC set the WTRU may use during E-DPCCH-less operation, high speed shared control channel (HS-SCCH) order to enable/disable E-DPCCH-less operation, RRC message with an activation time, or the like.

Optionally, even though configured with E-DPCCH-less operation, the WTRU may decide to send E-DPCCH with the first transmission if the happy bit needs to indicate to the network that the WTRU is not happy with the current grant.

The RV index may be obtained from the transmission timing only, and the RSN value may no longer be tied to a specified RV index. Since the RSN is not needed to convey the RV information, it may be possible to reduce the range of possible values for the RSN or change its interpretation in a way that is advantageous to system operation. The following options are possible for the re-interpretation of the RSN (the name RSN may also change).

The range of RSN values may be limited to 0 or 1 only, where 0 means the initial transmission and 1 means a retransmission (or vice-versa). Alternatively, the range of RSN values may be limited to 0 or 1 only, where toggling the value from 0 to 1 or from 1 to 0 means that new data is being transmitted in the TTI.

With either option above, there is 1 spare bit in the conventional 2-bit RSN bits of the E-DPCCH if the channel coding scheme of the prior art is kept. This spare bit may be used to repeat the value of the 1-bit RSN according to one of the above interpretations. This means that the value RSN=0 may be mapped to the 2-bit sequence “00” while the value RSN=1 may be mapped to the 2-bit sequence “11.” Alternatively, the sequences “01” and “10” may be used in place of “00” and “11.” This scheme allows the Node B to detect if there was an error on the received E-DPCCH.

Alternatively, the spare bit may be used to signal whether this is the last retransmission of the bundle or not. Alternatively, the spare bit may be used to indicate if there will be an autonomous retransmission or not in the next TTI. Such information is relevant to the Node B in case the number of autonomous retransmissions performed by the WTRU is varied dynamically according to radio conditions.

Alternatively, the spare bit may be used to signal if the uplink power headroom is above or below a certain threshold pre-signaled by the network (or pre-defined). Such information may be useful to the Node B to determine the activation or de-activation of autonomous retransmissions.

Embodiments for E-TFC restriction and selection with autonomous retransmissions or transmission bursts are explained hereafter. The number of autonomous retransmissions or the transmission burst duration that the WTRU performs may already be determined at the time that E-TFC selection is initiated. Alternatively, the number of autonomous retransmission or transmission burst duration may not be determined at the time of E-TFC selection but determined during the E-TFC selection, which will be explained later. The number of autonomous retransmissions or transmission burst duration may be determined based on physical layer or higher layer signaling from the network, or may be implicitly determined based on the configuration of certain parameters, such as those pertaining to E-TFC start time restriction. It should be noted that the embodiments below are described in the context of autonomous retransmissions, but the embodiments may also be applicable to transmission bursts in general. In this context, the number of transmission and autonomous retransmissions is equivalent to the transmission burst duration, which may be expressed in terms of the numbers of TTIs, (e.g., N_{TX} TTIs).

In accordance with one embodiment, a WTRU modifies the computation of the gain factor associated to a given E-TFC based on the number of autonomous retransmissions or transmission burst duration. The WTRU calculates the E-DPDCH gain factor β_{ed} as part of the E-TFC selection procedure. The required gain factor associated to a given E-TFC should be roughly inversely proportional to the transmission burst duration N_{TX} (in number of TTIs) or equivalently the total number of transmission and autonomous retransmissions (N_{TX}=N+1).

In accordance with a first method, the formula for calculating a temporary variable β_{ed,i,harq} in calculating the gain factor β_{ed} is modified such that the conventional temporary variable β_{ed,i,harq} is divided by N_{TX} as follows: In case the E-DPDCH power extrapolation formula is configured:

$${β}_{ed , i , harq} = \frac{1}{\sqrt{{N}_{TX}}} \cdot {β}_{ed , ref} \sqrt{\frac{{L}_{e , ref}}{{L}_{e , i}}} \sqrt{\frac{{K}_{e , i}}{{K}_{e , ref}}} \cdot {10}^{( \frac{Δ harq}{20} )} . \qquad Equation ( 10 )$$

In case the E-DPDCH power interpolation formula is configured:

$${β}_{ed , i , harq} = \frac{1}{\sqrt{{N}_{TX}}} \sqrt{\frac{{L}_{e , ref , 1}}{{L}_{e , i}}} \cdot \sqrt{( \begin{matrix}( \frac{\frac{{L}_{e , ref , 2}}{{L}_{e , ref , 1}} {β}_{ed , ref , 2}^{2} - {β}_{ed , red , 1}^{2}}{{K}_{e , ref , 2} - {L}_{e , ref , 1}} ) \\ ( {K}_{e , i} - {K}_{e , ref , 1} ) + {β}_{ed , ref , 1}^{2}\end{matrix} )} \cdot {10}^{( \frac{Δ harq}{20} )} ; \qquad Equation ( 11 )$$

with the exception that β_{ed,i,harq} is set to 0 if

$$( \frac{\begin{matrix}\frac{{L}_{e , ref , 2}}{{L}_{e , ref , 1}} {β}_{ed , ref , 2}^{2} - \\ {β}_{ed , ref , 1}^{2}\end{matrix}}{{K}_{e , ref , 2} - {K}_{e , ref , 1}} ) ( {K}_{e , i} - {K}_{e , ref , 1} ) + {β}_{ed , ref , 1}^{2} \leq 0. \qquad Equation ( 12 )$$

N_{TX} refers to the total number of transmission and autonomous retransmissions, (e.g., N_{Tx}=4 if there is 3 autonomous retransmissions after the initial transmission). All other parameters in Equations (10) and (11) are the same as defined in 3GPP TS 25.214.

Subsequent calculations for the gain factor β_{ed,k} for k-th E-DPDCH follow the same procedure as in the prior art, except utilizing the temporary variables β_{ed,i,harq} calculated based on Equation (10) or (11). In case compressed mode is utilized, the formulas for the E-DPDCH gain factor β_{ed,C,j} are modified in a similar manner, (i.e., a division by N_{TX} is included in the formula).

Optionally, the WTRU may be configured with an additional power offset (ΔTTI) associated to autonomous retransmissions or transmission bursts. This power offset may be used to compensate for the potentially different HARQ profile that would be applied to TTI bundles or transmission bursts. The power offset, ΔTTI, may be applied in the computation of the temporary variable β_{ed,i,harq} as follows: In case the E-DPDCH power extrapolation formula is configured:

$${β}_{ed , i , harq} = \frac{1}{\sqrt{{N}_{TX}}} \cdot {β}_{ed , ref} \sqrt{\frac{{L}_{e , ref}}{{L}_{e , i}}} \sqrt{\frac{{K}_{e , i}}{{K}_{e , ref}}} \cdot {10}^{( \frac{Δ harq}{20} )} \cdot {10}^{( \frac{Δ ATTI}{20} )} \qquad Equation ( 13 )$$

In case the E-DPDCH power interpolation formula is configured:

$${β}_{ed , i , harq} = \frac{1}{\sqrt{{N}_{TX}}} \sqrt{\frac{{L}_{e , ref , 1}}{{L}_{e , i}}} \cdot \sqrt{( \begin{matrix}( \frac{\frac{{L}_{e , ref , 2}}{{L}_{e , ref , 1}} {β}_{ed , ref , 2}^{2} - {β}_{ed , ref , 1}^{2}}{{K}_{e , ref , 2} - {K}_{e , ref , 1}} ) \\ ( {K}_{e , i} - {K}_{e , ref , 1} ) + {β}_{ed , ref , 1}^{2}\end{matrix} )} \cdot {10}^{( \frac{Δ harq}{20} )} \cdot {10}^{( \frac{Δ ATTI}{20} )} ; \qquad Equation ( 14 )$$

with the exception that β_{ed,i,harq} is set to 0 if

$$( \frac{\frac{{L}_{e , ref , 2}}{{L}_{e , ref , 1}} {β}_{ed , ref , 2}^{2} - {β}_{ed , ref , 1}^{2}}{{K}_{e , ref , 2} - {K}_{e , ref , 1}} ) ( {K}_{e , l} - {K}_{e , ref , 1} ) + {β}_{ed , ref , 1}^{2} \leq 0. \qquad Equation ( 15 )$$

The parameter N_{TX} may be replaced with a fixed scaling factor, (i.e., not necessarily equal to the total number of transmission and autonomous retransmissions), which is either signaled to the WTRU upon radio bearer configuration or reconfiguration, or pre-configured, (i.e., the WTRU always uses the same value).

In accordance with another method, the WTRU may directly adjust the E-DPDCH gain factor β_{ed,k} for the k-th E-DPDCH based on the number of autonomous retransmissions or the transmission burst duration. The E-DPDCHk gain factor β_{ed,k} is first calculated using the same method as in the prior art. After this calculation, the gain factor is adjusted to take into account the number of autonomous retransmissions or equivalently the transmission burst duration. The adjustment factor may be 1/N_{TX}, rounded down or up to the closest valid value of δ_{ed,k}. Optionally, an additional power offset, (e.g., similar to ΔTTI above), may be applied prior quantization to compensate for the potential different HARQ profile associated to the use of autonomous retransmissions.

Alternatively, the gain factor β_{ed,k} may be multiplied by a fixed scaling factor, (i.e., not necessarily equal to the total number of transmission and autonomous retransmissions), which is either signaled to the WTRU upon radio bearer configuration or reconfiguration, or pre-configured.

In accordance with yet another method, the normalized remaining power margin (NRPM) available for E-TFC restriction may be adjusted. The NRPMⱼ, as described in 3GPP TS 25.133, is used to determine whether an E-TFC shall be supported or not. The NRPMⱼ may be multiplied by the total number of transmissions and autonomous retransmissions for the transport blocks or alternatively by a scaling factor. The scaled NRPMⱼ may be used to determine whether or not an E-TFC is supported when autonomous retransmissions are configured. Optionally, an additional power offset, (e.g., similar to ΔTTI above), may be further applied to the scaled NRPMⱼ for example to compensate for the potential different HARQ profile associated to the use of autonomous retransmissions. With either method the new value of β_{ed,k} is used in the determination of whether an E-TFC is supported or not, (i.e., to determine the set of restricted E-TFCs).

In accordance with another embodiment, a WTRU may calculate up to two sets of supported E-TFCs in the E-TFC restriction procedure. The first set of supported E-TFCs is calculated using the conventional E-TFC restriction procedure assuming no transmission burst or autonomous retransmissions are taking place. The second set of supported E-TFCs may be calculated assuming a fixed number of autonomous retransmissions or a fixed transmission burst duration. Optionally, the WTRU may only calculate the second set of supported E-TFCs if the largest E-TFC in the first set is equal to or smaller than the minimum E-TFC. These two sets are then used in the E-TFC selection. The second set of supported E-TFCs may be calculated by any one of the methods described above. Optionally, the second set of supported E-TFCs may be calculated by using a second set of reference E-TFCI power offsets. This second set of reference E-TFCI power offsets may be received by the WTRU via RRC signaling.

In accordance with yet another embodiment, the WTRU may calculate the number of autonomous retransmissions or the transmission burst duration. The WTRU may calculate the set of supported E-TFCs in the E-TFC restriction procedure using the conventional procedure. In addition, the WTRU also calculates the transmission burst duration or total number of transmissions required (N_{TX}) for each E-TFC. Optionally, and to simplify the procedure, the WTRU may only calculate the transmission burst duration or the number of transmissions required for each E-TFC below a given threshold. The threshold may be the E-DCH minimum E-TFC or another configured value.

The transmission burst duration or the number of transmissions required for a given E-TFC may be calculated for example by finding the minimum N_{TX} such that

$$NRPMj \geq \frac{1}{{N}_{TX}} \sum {( \frac{{β}_{ed , j}}{{β}_{c}} )}^{2} , \qquad Equation ( 16 )$$

where NRPMⱼ is calculated using the conventional procedure without assuming TTI bundling. Optionally, an additional power offset may be added for example to compensate for a different HARQ profile associated to autonomous retransmissions. This may be achieved, for example, using the following formula instead of the one above, where ΔTTI represents the power offset:

$$NRPMj \geq \frac{1}{{N}_{TX}} \sum {( \frac{{β}_{ed , j}}{{β}_{c}} )}^{2} {10}^{( \frac{Δ ATTI}{20} )} . \qquad Equation ( 17 )$$

In the above examples, the calculation is carried out after quantization of the gain factors. Alternatively, the calculation may be carried out before quantization of the gain factor. Similar approaches may be used taking into considerations E-DPCCH boosting as well as possible compressed mode gaps.

Alternatively, or in addition to modifying the E-TFC restriction procedure, the serving grant based E-TFC selection procedure may be modified to take into account the autonomous retransmissions that are performed by the WTRU.

In case that the scope of serving grant covers autonomous transmissions, the Serving_Grant that is calculated by the serving grant function and used for E-TFC selection may be divided by N_{TX}. N_{TX} is the total number of transmission and autonomous retransmissions in a transmission burst. Alternatively, the Serving_Grant value may be multiplied by a scaling factor that is signaled to the WTRU upon radio bearer configuration/reconfiguration, or pre-configured.

The maximum number of bits for the upcoming transmission may be calculated from the number of bits corresponding to the reference E-TFCs (E-TFC_{ref,m}). If E-DPDCH power extrapolation formula is configured, the highest value is lower or equal to:

$$⌊ {K}_{e , ref , m} \cdot \frac{Serving\_Grant / {N}_{TX}}{{L}_{e , ref , m} \cdot {A}_{ed , ref , m}^{2} \cdot {10}^{Δ harq / 10}} ⌋ . \qquad Equation ( 18 )$$

This maximum number of bits shall be lower than K_{e,ref,n} bits, where K_{e,ref,n} corresponds to any higher n^{th} reference E-TFC (E-TFC_{ref,n}) and shall be higher or equal to K_{e,ref,m} of E-TFC_{ref,m} except if m=1.

If E-DPDCH power interpolation formula is configured, the highest value is lower or equal to:

$$⌊ {K}_{e , ref , m} + \frac{( \begin{matrix}\frac{Serving\_Grant / {N}_{TX}}{{10}^{{ }^{Δ harq / 10}}} - \\ {L}_{e , ref , m} \cdot {A}_{ed , ref , m}^{2}\end{matrix} ) ( {K}_{e , ref , m + 1} - {K}_{e , ref , m} )}{\begin{matrix}{L}_{e , ref , m + 1} \cdot {A}_{ed , ref , m + 1}^{2} - \\ {L}_{e , ref , m} \cdot {A}_{ed , ref , m}^{2}\end{matrix}} ⌋ . \qquad Equation ( 19 )$$

This maximum number of bits shall be lower than K_{e,ref,m+1} bits except if K_{e,ref,m+1} corresponds to the number of bits of the highest reference E-TFC (E-TFC_{ref, M}) and shall be higher or equal to K_{e,ref,m} of E-TFC_{ref,m} except if m=1. N_{TX} refers to the total number of transmission and autonomous retransmissions (for instance, N_{TX}=4 if there is 3 autonomous retransmissions after the initial transmission). All other parameters in Equations (18) and (19) are the same as defined in 3GPP TS 25.214.

In case that the scope of serving grant is per TTI, the serving-grant based E-TFC selection may be modified to take into account the lower transmission power that is used for E-DPDCH, (e.g., scaling of β_{ed,i,harq} above). In accordance with one embodiment, the parameter A_{ed,ref,m′} which corresponds to the signaled reference amplitude ratio, may be scaled-down to take into account the number of retransmissions or the transmission burst duration. The maximum number of bits for the upcoming transmission is calculated from the number of bits corresponding to the reference E-TFCs (E-TFC_{ref,m}). If E-DPDCH power extrapolation formula is configured, the highest value is lower or equal to:

$$⌊ {K}_{e , ref , m} \cdot \frac{Serving\_Grant}{{L}_{e , ref , m} \cdot {A}_{ed , ref , m}^{2} / {N}_{TX} \cdot {10}^{Δ harq / 10}} ⌋ . \qquad Equation ( 20 )$$

This maximum number of bits shall be lower than K_{e,ref,n} bits, where K_{e,ref,n} corresponds to any higher n^{th} reference E-TFC (E-TFC_{ref,n}) and shall be higher or equal to K_{e,ref,m} of E-TFC_{ref,m} except if m=1.

If E-DPDCH power interpolation formula is configured, the highest value is lower or equal to:

$$⌊ {K}_{e , ref , m} + \frac{\begin{matrix}( \begin{matrix}\frac{Serving\_Grant}{{10}^{Δ harq / 10}} - \\ {L}_{e , ref , m} \cdot {A}_{ed , ref , m}^{2} / {N}_{TX}\end{matrix} ) \\ ( {K}_{e , ref , m + 1} - {K}_{e , ref , m} )\end{matrix}}{\begin{matrix}{L}_{e , ref , m + 1} \cdot {A}_{ed , ref , m + 1}^{2} / {N}_{TX} - \\ {L}_{e , ref , m} \cdot {A}_{ed , ref , m}^{2} / {N}_{TX}\end{matrix}} ⌋ . \qquad Equation ( 21 )$$

This maximum number of bits shall be lower than K_{e,ref,m+1} bits except if K_{e,ref,m+1} corresponds to the number of bits of the highest reference E-TFC (E-TFC_{ref, M}) and shall be higher or equal to K_{e,ref,m} of E-TFC_{ref,m} except if m=1. N_{TX} refers to the total number of transmission and autonomous retransmissions or equivalently to the transmission burst duration in terms of number of TTIs, and all other parameters in Equations (20) and (21) are the same as defined in 3GPP TS 25.214. Instead of N_{TX}, a fixed scaling factor may be used, which is either signaled to the WTRU upon radio bearer configuration/reconfiguration, or pre-configured.

Optionally, an additional power offset may be added to Equations (18)-(21) when TTI bundling or autonomous retransmissions are used. This power offset may be configured by the network to compensate for a different HARQ profile associated to TTI bundling transmissions. In such cases, Equations (18)-(21) may be expressed respectively as follows:

$$\begin{matrix}⌊ {K}_{e , ref , m} \cdot \frac{Serving\_Grant / {N}_{TX}}{{L}_{e , ref , m} \cdot {A}_{ed , ref , m}^{2} \cdot {10}^{Δ harq / 10} \cdot {10}^{Δ ATTI / 10}} ⌋ , & Equation ( 22 ) \\ ⌊ {K}_{e , ref , m} + \frac{( \begin{matrix}\frac{Serving\_Grant / {N}_{TX}}{{10}^{Δ harq / 10} \cdot {10}^{Δ ATTI / 10}} - \\ {L}_{e , ref , m} \cdot {A}_{ed , ref , m}^{2}\end{matrix} ) ( {K}_{e , ref , m + 1} - {K}_{e , ref , m} )}{\begin{matrix}{L}_{e , ref , m + 1} \cdot {A}_{ed , ref , m + 1}^{2} - \\ {L}_{e , ref , m} \cdot {A}_{ed , ref , m}^{2}\end{matrix}} ⌋ , & Equation ( 23 ) \\ ⌊ {K}_{e , ref , m} \cdot \frac{Serving\_Grant}{\begin{matrix}{L}_{e , ref , m} \cdot {A}_{ed , ref , m}^{2} / {N}_{TX} \\ {10}^{Δ harq / 10} \cdot {10}^{Δ ATTI / 10}\end{matrix}} ⌋ , & Equation ( 24 ) \\ ⌊ {K}_{e , ref , m} + \frac{( \begin{matrix}\frac{Serving\_Grant}{{10}^{Δ harq / 10} \cdot {10}^{Δ ATTI / 10}} - \\ {L}_{e , ref , m} \cdot {A}_{ed , ref , m}^{2} / {N}_{TX}\end{matrix} ) ( {K}_{e , ref , m + 1} - {K}_{e , ref , m} )}{\begin{matrix}{L}_{e , ref , m + 1} \cdot {A}_{ed , ref , m + 1}^{2} / {N}_{TX} - \\ {L}_{e , ref , m} \cdot {A}_{ed , ref , m}^{2} / {N}_{TX}\end{matrix}} ⌋ . & Equation ( 25 )\end{matrix}$$

In accordance with another embodiment, the number of autonomous retransmissions or equivalently the transmission burst duration is not pre-determined before E-TFC selection, but determined during E-TFC selection. The WTRU knows the maximum number of autonomous retransmissions that it may perform, but will only determine the actual number of autonomous retransmissions (or transmission burst duration) during the E-TFC selection procedure. Autonomous retransmissions (or transmission burst) may only be performed in case there is insufficient power margin on the initial transmission to support the allowed power ratio per a scheduled or non-scheduled grant. Alternatively, autonomous retransmissions (or transmission burst) may only be performed when the largest supported E-TFC, as obtained by the E-TFC restriction procedure, is smaller than or equal to the minimum E-TFC.

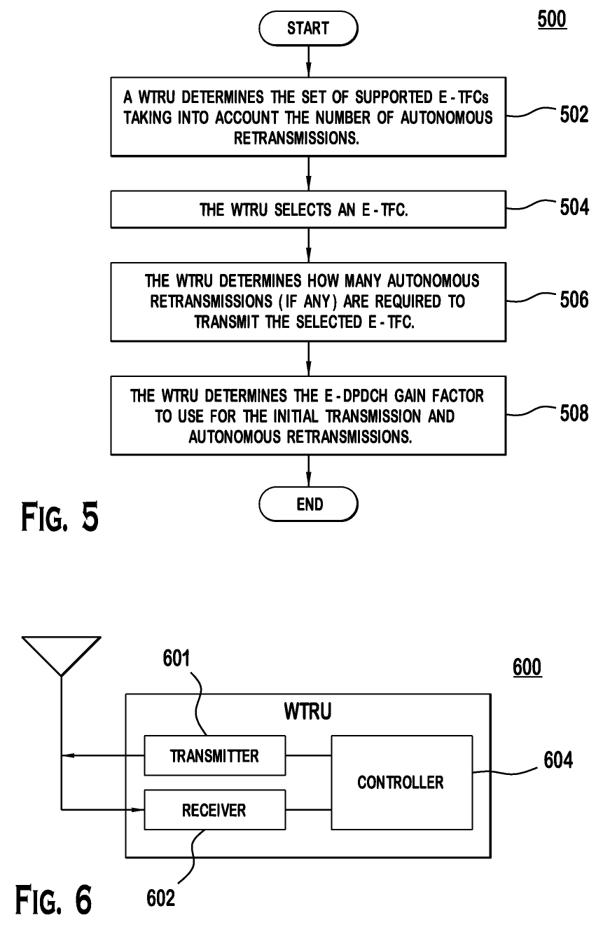

FIG. 5 is a flow diagram of an example process 500 for E-TFC selection in accordance with this embodiment. The WTRU determines the set of supported E-TFCs, (i.e., E-TFC restriction) taking into account the number of autonomous retransmissions (step 502). For performing the E-TFC restriction, the WTRU calculates conventional normalized remaining power margin (NRPMⱼ) for each E-TFC and multiplies this conventional NRPMⱼ with the total number of transmissions and autonomous retransmissions for the transport blocks (or alternatively a scaling factor). Using the adjusted NRPMⱼ it is determined whether the E-TFC j is in supported state or not.

This is equivalent to using the following Equation (26) for NRPMⱼ in place of the conventional formula:

NRPMⱼ=N_{TX}×(PMaxⱼ−P_{DPCCH, target}−P_{DPDCH}−P_{HS-DPCCH}−P_{E-DPCCH,j})/P_{DPCCH,target}; Equation (26)

where N_{TX} is the maximum total number of transmission and autonomous retransmissions, and all other parameters are the same as defined in 3GPP TS 25.133. Alternatively, the following Equation (27) may be used if the power of the E-DPCCH is to be reduced according to the number of retransmissions:

NRPM^{j}=N_{TX}×(PMaxⱼ−P_{DPCCH, target}−P_{DPDCH}−P_{HS-DPCCH}−P_{E-DPCCH,j}/N_{TX})/P_{DPCCH, target}. Equation (27)

Alternatively, the value of PMaxᵢ in Equations (26) or (27) may be adjusted by multiplying the total number of transmission and autonomous retransmissions (N_{TX}) or by a pre-determined or configured scaling factor.

The WTRU selects an E-TFC (step 504). The E-TFC is selected as in prior art. The difference is that the set of supported E-TFCs used in the determination of the maximum supported payload, (i.e., the maximum MAC-e or MAC-i PDU size that may be sent by the WTRU during upcoming transmission), is calculated taking into account the maximum total number of transmission and autonomous retransmissions.

The WTRU determines how many autonomous retransmissions (if any) are required to transmit the selected E-TFC (step 506). In determining this, the WTRU considers the power ratio β_{ed,j}/β_{c} (or β_{ed,C,j}/β_{c} if compressed mode is configured) required to transmit the selected E-TFCⱼ. For instance, the total number of transmission plus autonomous retransmission N_{TX} may be the smallest N_{TX} satisfying the following equation:

$${NRPM}_{j , {N}_{TX}} \geq \sum {( \frac{{β}_{ed , j}}{{β}_{c}} )}^{2} ; \qquad Equation ( 28 )$$

where NRPM_{j,N}_{_{TX}}=N_{TX}×(PMaxⱼ−P_{DPCCH, target}−P_{DPDCH}−P_{HS-DPCCH}−P_{E-DPCCH,j})/P_{DPCCH,target}.

Alternatively, if the power of the E-DPCCH is to be reduced according to the number of retransmissions:

NRPM_{j,N}_{_{TX}}=N_{TX}×(PMaxⱼ−P_{DPCCH, target}−P_{DPDCH}−P_{HS-DPCCH}−P_{E-DPCCH,j}/N_{TX})/P_{DPCCH, target}. Equation (29)

In case compressed mode is configured, the value of N_{TX} may be the smallest N_{TX} satisfying the following equation:

$${NRPM}_{j , {N}_{TX}} \geq \sum {( \frac{{β}_{ed , C , j}}{{β}_{c}} )}^{2} ; \qquad Equation ( 30 )$$

where NRPM_{j,N}_{_{TX}} is calculated using one of the above equations. In Equations (28)-(30), all other parameters are defined in 3GPP TS 25.133.

The WTRU determines the E-DPDCH gain factor (β_{ed}) to use for the initial transmission and autonomous retransmissions (step 508). In case N_{TX}=1, (i.e., no autonomous retransmission required), this power ratio may be exactly the same as the one originally obtained to transmit the E-TFC β_{ed,j} (or β_{ed,C,j} if compressed mode is configured). In case N_{TX}>1, an E-DPDCH gain factor may be used such that the WTRU is transmitting at maximum power for all transmissions (including autonomous retransmissions). Alternatively, the smallest valid gain factor β_{ed} may be used such that β_{ed} is larger than or equal to (β_{ed,j}/N_{TX}), (in case compressed mode is configured, larger than or equal to (β_{ed,C,j}/N_{TX})). Alternatively, the largest valid gain factor β_{ed} may be used such that β_{ed} is smaller than or equal to (β_{ed,j}/N_{TX}), (in case compressed mode is configured, smaller than or equal to (β_{ed,C,j}/N_{TX})).

The WTRU may determine to perform autonomous retransmission if one or a combination of the following conditions are met:

(1) Common pilot channel (CPICH) measurement such as received signal code power (RSCP) or Ec/No falls below a threshold;

(2) Path loss measurement falls below a threshold;

(3) Channel quality indicator (CQI) measurement falls below a threshold;

(4) The number of failed E-DCH MAC-i or MAC-e PDU (or optionally downlink MAC protocol data units (PDUs)) in a configured period of time falls above a threshold;

(5) The number of consecutively failed E-DCH MAC-i or MAC-e PDU (or optionally downlink MAC PDUs) is above a threshold;

(6) The quality of fractional dedicated physical channel (F-DPCH) or DPCCH falls below a threshold;

(7) Lack of supported E-TFC as obtained from the E-TFC restriction procedure;

(8) The largest supported E-TFC as obtained from the E-TFC restriction procedure is smaller than or equal to the largest E-TFC of the minimum E-TFC set;

(9) The E-TFC restriction has provided or associated the E-TFCs with a number of autonomous retransmissions; or

(10) The WTRU total transmit power would exceed the maximum allowed value for a HARQ retransmission.

The thresholds described above may be pre-determined, pre-configured or received by the WTRU via RRC signaling. The autonomous retransmissions may be stopped if the conditions described above are no longer true.

Possible dynamic TTI bundle scenarios are described hereafter. In a first example, an E-TFC restriction provides a list of supported E-TFCs according to the conventional rules. If the largest supported E-TFC provided by the E-TFC restriction procedure is smaller than or equal to the E-DCH minimum set E-TFC, then TTI bundling is applied for the upcoming E-DCH transmission. In the E-TFC selection, an additional power offset may be applied on top of the HARQ profile power offset (ΔHARQ) to compensate for a possibly different HARQ profile for the bundle. The serving grant may be multiplied by N_{TX} to take into account the autonomous retransmissions or the additional TTIs in the transmission burst. The MAC entity delivers the PDU to the physical layer, which takes care of the autonomous retransmissions or creating the transmission burst. The MAC entity may block the (N_{TX}−1) following TTIs for new transmission because PHY is busy transmitting. N_{TX} may be a fixed parameter or may be provided by the E-TFC restriction or physical layer dynamically. This approach is simple in that the E-TFC selection does not need to be changed significantly and the autonomous retransmissions or transmission burst are taken care of at the physical layer.

In a second example, E-TFC restriction provides the list of supported E-TFCs according to the conventional rules. For each E-TFC in supported state (as defined by the E-TFC restriction procedure) smaller than or equal to the minimum supported E-TFC, the E-TFC restriction provides an additional E-TFC (if larger than the E-DCH minimum set E-TFC), which corresponds to the supported E-TFC applicable when a fixed-size TTI bundle is used for transmission with the potential adjustment in HARQ offset due to bundling. If the largest supported E-TFC (as defined by the E-TFC restriction procedure with no bundling) is smaller than or equal to the minimum supported E-TFC, then TTI bundling is applied for the upcoming transmission and the minimum supported E-TFC is the one provided by E-TFC restriction for TTI bundling. In the E-TFC selection, an additional power offset may be applied on the top of the HARQ profile power offset (ΔHARQ) to compensate for a possibly different HARQ profile for the bundle. The serving grant is multiplied by N_{TX} to take into account the autonomous retransmissions. The MAC entity delivers the PDU to the physical layer, which takes care of the autonomous retransmissions. The MAC entity should block the (N_{TX}−1) following TTIs for new transmission because PHY is busy transmitting. N_{TX} may be a fixed parameter or may be provided by the E-TFC restriction or physical layer dynamically.

In a third example to support continuous TTI bundling operations, (i.e., the WTRU uses TTI bundles continuously for a period of time either determined by the network or determined by implicit rules at the WTRU), the WTRU uses a fixed and known number of autonomous retransmissions. At every TTI for which a TTI bundle begins, E-TFC restriction provides a list of supported E-TFCs taking into considerations the fixed bundle size and the possible additional power offset associated to bundling. The conventional E-TFC selection method is carried out by taking into consideration of the TTI bundle size. This may be achieved for example by using one of the embodiments described above. The MAC entity delivers the PDU to the physical layer, which takes care of the autonomous retransmissions. The MAC entity should block the (N_{TX}−1) following TTIs for new transmission because PHY is busy transmitting.

In a fourth example if the largest supported E-TFC provided by the E-TFC restriction procedure is larger than or equal to the E-DCH minimum set E-TFC, then TTI bundling is not applied for the first E-DCH HARQ transmission. If the WTRU total transmit power would exceed the maximum allowed value for any HARQ retransmission, then the WTRU may apply TTI bundling for that HARQ retransmission. The physical layer then may, for example, repeat the failed HARQ transmission for N_{TX} consecutive TTIs, starting when the HARQ retransmission would normally begin.

FIG. 6 is a block diagram of an example WTRU 600. The WTRU includes a transmitter 601, a receiver 602, and a controller 604. The transmitter 601 is configured to generate an E-DCH transport block and transmit a transmission burst over at least two consecutive TTIs. The controller 604 may be configured to implement control functions in accordance with the embodiments disclosed above. For example, the controller 604 may be configured to determine a set of supported E-TFCs, select an E-TFC for the E-DCH transport block, and transmit the transmission burst via a HARQ process configured for autonomous retransmissions. The transmission burst includes an initial transmission of the E-DCH transport block over a first TTI in the transmission burst followed by at least one retransmission of the E-DCH transport block over at least one subsequent TTI in the transmission burst. The E-DCH transport block is transmitted via an E-DPDCH, and control information necessary for decoding the E-DPDCH being transmitted via an E-DPCCH. The controller 604 may be configured to retransmit the transmission burst on a condition that the transmission burst fails. The controller 604 may be configured to include an RSN in the E-DPCCH and increment the RSN each time the transmission burst is retransmitted. The RV for the E-DCH transport block for each TTI may be indicated by parameters including a TTI number and a number of autonomous retransmissions (N) in the transmission burst.

The controller 604 may be configured to increment the RV each time the transport block is retransmitted and reset the RV each time the transmission burst is retransmitted. The controller 604 may be configured to increment the RV each time the transport block is retransmitted and not to reset the RV upon retransmission of the transmission burst. The controller 604 may be configured to set the RV based on a configured RV pattern. The controller 604 may be configured to set the RV for each retransmission of the transport block to a value that would be used if the E-DCH transport block is sent without autonomous retransmissions.

The controller may be configured to spread total E-DPCCH power that would have been allocated to the E-DPCCH when no autonomous retransmissions over all transmissions in the transmission burst. The controller 604 may be configured to transmit the E-DPCCH only during a first TTI of the transmission burst. The controller 604 may be configured to transmit the E-DPCCH periodically in the transmission burst.

The controller 604 may be configured to utilize only a subset of TBS and modulation available for the E-DCH and disable the E-DPCCH during the transmission burst. The controller 604 may be configured to calculate a temporary variable β_{ed,i,harq}, adjust the temporary variable β_{ed,i,harq} by dividing by one of a total number of transmissions in the transmission burst and a scaling factor, calculate a gain factor β_{ed} based on the adjusted temporary variable β_{ed,i,harq}, and determine the set of supported E-TFCs based on the gain factor β_{ed}. The controller 604 may be configured to calculate a gain factor β_{ed}, divide the gain factor β_{ed} by one of a total number of transmissions in the transmission burst and a scaling factor, and determine the set of supported E-TFCs based on the gain factor β_{ed}. The controller 604 may be configured to calculate an NRPMⱼ for each E-TFCⱼ, adjust the NRPMⱼ by multiplying one of a total number of transmissions in the transmission burst and a scaling factor, and determine the set of supported E-TFCs based on the adjusted NRPMⱼ. The controller 604 may be configured to calculate a serving grant, divide the serving grant by one of a total number of transmissions in the transmission burst and a scaling factor, and calculate a maximum number of bits for upcoming transmission based on the adjusted serving grant. The controller 604 may be configured to calculate a serving grant, divide a reference amplitude ratio by one of a total number of transmissions in the transmission burst and a scaling factor, and calculate a maximum number of bits for upcoming transmission based on the adjusted reference amplitude ratio. The controller 604 may be configured to determine a number of autonomous retransmissions required to transmit the selected E-TFC, and determine a gain factor to be used for the initial transmission and autonomous retransmissions.

The controller 604 may be configured to set an E-DPCCH power offset to a transmission burst-specific E-DPCCH gain factor value. The controller 604 may be configured to calculate a power of the E-DPCCH by dividing a normal E-DPCCH power offset by a total number of TTIs in the transmission burst. The controller 604 may be configured to transmit the E-DPCCH only during a first TTI of the transmission burst. The controller 604 may be configured to scale an E-DPDCH gain factor during the first TTI of the transmission burst to avoid transmitting above a maximum allowed transmission power. The controller 604 may be configured to scale an E-DPDCH gain factor for at least one TTI of the transmission burst such that a total required transmission power is transmitted during the transmission burst.

The controller 604 may be configured to transmit the E-DPDCH during the transmission burst such that a maximum allowed transmission power is reached. The set of supported E-TFCs may be a second set of supported E-TFCs that is determined only for use with the transmission burst. The second set of supported E-TFCs may be determined on a condition that a largest supported E-TFC is smaller than a minimum E-TFC. The second set of supported E-TFCs may be determined using the second set of reference power offsets. The controller 604 may be configured to perform uplink HARQ transmission in a burst on at least one of conditions that a largest supported E-TFC is smaller than a minimum E-TFC, the selected E-TFC is associated with a transmission burst duration longer than one TTI, a transmission power associated to the selected E-TFC exceeds a maximum allowed transmission power, or a previous HARQ transmission has failed.

The controller 604 may be configured to determine the set of supported E-TFCs and the E-TFC for transmission based on a number of TTIs in the transmission burst. The controller 604 may be configured to receive a power offset for different transmission burst HARQ profile, and apply an additional power offset to an E-DPDCH gain factor.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

1. A method for use in a wireless transmit/receive unit (WTRU) for performing uplink hybrid automatic repeat request (HARQ) transmission in a burst, the method comprising:
determining a set of supported enhanced dedicated channel (E-DCH) transport format combinations (E-TFCs);
selecting an E-TFC for an E-DCH transport block;
generating an E-DCH transport block; and
transmitting a transmission burst over at least two consecutive transmission time intervals (TTIS) via a HARQ process configured for transmission burst, the transmission burst including transmission of the E-DCH transport block, the E-DCH transport block being transmitted via an E-DCH dedicated physical data channel (E-DPDCH), control information necessary for decoding the E-DPDCH being transmitted via an E-DCH dedicated physical control channel (E-DPCCH), wherein the set of supported E-TFCs and the selected E-TFC are determined based on a number of TTIs in the transmission burst.

2. The method of claim 1 further comprising:
receiving a power offset for different transmission burst HARQ profile, wherein an additional power offset is applied to an E-DPDCH gain factor.

3. The method of claim 1 further comprising:
receiving a set of reference power offsets for transmission burst, wherein the set of supported E-TFCs for a transmission burst is determined using the set of reference power offsets.

4. The method of claim 1 wherein the WTRU performs uplink HARQ transmission in a burst on at least one of conditions that a largest supported E-TFC is smaller than a minimum E-TFC, the selected E-TFC is associated to a transmission burst duration longer than one TTI, a transmission power associated to the selected E-TFC exceeds a maximum allowed transmission power, or a previous HARQ transmission has failed.

5. The method of claim 1, further comprising the WTRU receiving a transmission burst-specific E-DCH dedicated physical control channel (E-DPCCH) power offset value, wherein an E-DPCCH power offset is set to the transmission burst-specific E-DPCCH power offset value.

6. The method of claim 1 wherein the WTRU calculates an E-DPCCH power offset by dividing an E-DPCCH power offset by a total number of TTIs in the transmission burst.

7. The method of claim 1 wherein the WTRU transmits the E-DPCCH only during a first TTI of the transmission burst.

8. The method of claim 1 further comprising:
scaling an E-DPDCH gain factor for at least one TTI of the transmission burst such that a total required transmission power is transmitted during the transmission burst.

9. The method of claim 1 wherein the WTRU transmits the E-DPDCH during the transmission burst such that a maximum allowed transmission power is reached.

10. The method of claim 1 further comprising:
calculating an E-DPDCH power offset by dividing a conventional E-DPDCH power offset by a total number of TTIs in the transmission burst.

11. A wireless transmit/receive unit (WTRU) configured to perform uplink hybrid automatic repeat request (HARQ) transmission in a burst, the WTRU comprising:
a controller configured to determine a set of supported enhanced dedicated channel (E-DCH) transport format combinations (E-TFCs), and select an E-TFC for an E-DCH transport block, the set of supported E-TFCs and the selected E-TFC being determined based on a number of transmission time intervals (TTIs) in a transmission burst; and
a transmitter configured to transmit a transmission burst over at least two consecutive TTIs via a HARQ process configured for transmission burst, the transmission burst including transmission of an E-DCH transport block, the E-DCH transport block being transmitted via an E-DCH dedicated physical data channel (E-DPDCH), control information necessary for decoding the E-DPDCH being transmitted via an E-DCH dedicated physical control channel (E-DPCCH).

12. The WTRU of claim 11 wherein the controller is configured to receive a power offset for different transmission burst HARQ profile, and apply an additional power offset to an E-DPDCH gain factor.

13. The WTRU of claim 11 wherein the controller is configured to receive a set of reference power offsets for transmission burst, and determine the set of supported E-TFCs using the set of reference power offsets.

14. The WTRU of claim 11 wherein the controller is configured to perform uplink HARQ transmission in a burst on at least one of conditions that a largest supported E-TFC is smaller than a minimum E-TFC, the selected E-TFC is provided with a transmission burst duration longer than one TTI, a transmission power associated to the selected E-TFC exceeds a maximum allowed transmission power, or a previous HARQ transmission has failed.

15. The WTRU of claim 11 wherein the controller is configured to receive a transmission burst-specific E-DCH dedicated physical control channel (E-DPCCH) power offset value, and set an E-DPCCH power offset to the transmission burst-specific E-DPCCH power offset value.

16. The WTRU of claim 11 wherein the controller is configured to calculate an E-DPCCH power offset by dividing an E-DPCCH power offset by a total number of TTIs in the transmission burst.

17. The WTRU of claim 11 wherein the controller is configured to control the transmitter to transmit the E-DPCCH only during a first TTI of the transmission burst.

18. The WTRU of claim 11 wherein the controller is configured to scale an E-DPDCH gain factor for at least one TTI of the transmission burst such that a total required transmission power is transmitted during the transmission burst.

19. The WTRU of claim 11 wherein the controller is configured to transmit the E-DPDCH during the transmission burst such that a maximum allowed transmission power is reached.

20. The WTRU of claim 11 wherein the controller is configured to calculate an E-DPDCH power offset by dividing a conventional E-DPDCH power offset by a total number of TTIs in the transmission burst.
